(19) United States
(12) Patent Application Publication
(10) Pub. No.: US 2002/0190991 A1
(43) Pub. Date: Dec. 19, 2002

(54) 3-D instant replay system and method

(76) Inventors: Daniel Efran, Pittsburgh, PA (US); Mark Ollis, Pittsburgh, PA (US); Todd Williamson, Philadelphia, PA (US)

Correspondence Address: Wen Liu, LIU & LIU LLP, Suite 1100, 811 West 7th Street, Los Angeles, CA, 90017, US

(21) Appl. No.: 10/150,533

(22) Filed: May 16, 2002

Related U.S. Application Data
(60) Provisional application No. 60/291,885, filed on May 16, 2001.
(60) Provisional application No. 60/338,350, filed on Nov. 30, 2001.

(51) Int. Cl. G06T 13/00

(52) U.S. Cl. 345/475

(57) ABSTRACT

A 3-D Instant Replay system is disclosed for the capture, adjustment, and generation substantially in real time of complex 3-D or other video effects. A camera array is configured about a desired scene for effect generation. Image information from multiple cameras is sent instantaneously and simultaneously to a capture system. Multiple capture devices may be used together in the capture system to capture video information from a large number of cameras. Once inside each capture device, image data is made available in the memory element of the capture system for generation of realtime effects. A host system, connected via high speed networking elements to the capture system, selects relevant portions of available image data from the capture system (or each capture device) based on preset criteria or user input. An effect generation algorithm, optionally including image correction and adjustment processes, on the host system creates the desired video effect and outputs generated image frames in a desired format for viewing.

This application makes a claim of priority from U.S. Provisional Application No. 60/291,885 (attorney docket no. 1030/204), entitled “Virtual Camera Trajectories for 3D Instant Replay”, filed May 16, 2001 in the name of Williamson, and U.S. Provisional Application No. 60/338,350 (attorney docket no. 1030/205), entitled “3D Instant Replay System”, filed Nov. 30, 2001 in the names of Efran et. Al, both of which are commonly assigned to Zaxel Systems, Inc., the assignee of the present invention.

### BACKGROUND OF THE INVENTION

1. Field of the Invention

This invention relates generally to a system and method for creating immediate three-dimensional or other video effects of a particular object or scene. Particularly it relates to the real-time capture of multiple video streams and simultaneous availability of calibrated and corrected images from such streams in a computer based system for the generation of three-dimensional or other video effects.

2. Description of Related Art

Certain desirable video effects (such as a three-dimensional “fly-around” effects) have in the past been obtained using a single camera. Because of the size and mobility limitations inherent in the camera rig systems necessary to enable such single camera effects, certain shots can be very difficult to accomplish practically in many settings. Further, three-dimensional (3-D) “freeze-and-rotate” type effects (generated from a single instance of time) gaining popularity in both broadcast television and feature films are physically impossible to accomplish with a single camera as image information from multiple viewpoints is necessary from the same instant in time.

Traditional “instant replay” video systems involve a camera directed at a particular scene whose output can be selectively recorded and then played back on a user cue. In such systems, playback generally may occur relatively quickly after a user cue has been initiated such that footage of a prior event from the scene may be successively broadcast one or more times to viewers (generally of a live television program). Often, such instant replay scenes are shown in slow motion, or may be generated using footage from another camera directed at the scene to provide viewers additional visual representations. With current instant replay systems, even systems incorporating multiple cameras to capture a subject event from different viewpoints, it is not possible to generate certain desirable effects.

Prior 3-D visual effect systems have demonstrated the benefits of using an array or bank of cameras surrounding a particular desired scene. Generally such systems have included the configuration of many cameras about a scene, and various methods for combining the captured images into a final effect. Because such a large number of cameras is necessary to create the effect of one single camera following a trajectory about the scene, these traditional approaches have utilized relatively simplistic camera systems and required lengthy processing times on both individual captured images and final output effects. This can be attributed generally to the inherent difficulty of rapidly and simultaneously providing relevant images from many cameras in to one common location for processing and effect generation.

For instance, U.S. Pat. No. 6,331,871 describes a system for producing virtual camera motion in a motion picture medium by using an array of still cameras to capture images, and then individually placing those images in a motion picture medium. While this and similar systems can provide the means for capturing picture information sufficient to generate certain video effects, none have addressed the difficulties involved in providing such information rapidly and simultaneously, whether directly to a viewer in the form of a generated effect, or to a user for cueing and immediate creation of such effects (such as in an instant replay systems). Further, such systems do not allow for the real-time monitoring of and interaction with footage being captured by the system such that 3-D effects from recently occurring events may be generated at a desired time.

It would be desirable to provide a system capable of capture and selective instant playback and effect generation from the footage of many cameras, especially from cameras arranged in an arcuate array about a scene to produce 3-D freeze-and-rotate effects. There is therefore a need for making immediately available visual imagery from a large number of cameras to provide high quality desirable video effects in a rapid manner such that 3-D instant replay effects are possible during a live broadcast to viewers which overcomes the shortcomings in the prior art.

### SUMMARY OF THE INVENTION

The present invention is directed to a 3-D effect generation system and underlying structure and architecture, which overcomes drawbacks in the prior art. (The system will sometimes be referred to as the 3-D Instant Replay system herein-below.) The system of the present invention is capable of generating high quality, instantly replayable 3-D rotational effect (such as a 3-D freeze-and-rotate or 3D “fly-around” effects) of a scene which appears to be frozen in time, as well as other effects which require multiple simultaneous (or very close in time) viewpoints of a particular scene. In one aspect of the present invention there is provided a calibrated camera array positioned about a scene from which the final effect will be generated. Video information from each camera is transmitted substantially simultaneously to a series of networked “capture” computer systems (capture systems) where the data is stored temporarily in memory for use in video effects. A “host” computer system (host system) commonly networked to each capture system selects certain images from the set of available image data (across all capture systems) based on preset criteria or user input for use in final effect generation. Image adjustment and correction processes are performed on each selected image in the host system prior to or during effect generation using camera calibration data as the reference from which to modify image data. Adjusted and corrected images are combined in a known video format for completion of the effect and output in a desire medium.

In another aspect of the present invention, image adjustment processes are preformed on image data stored in each capture system based on predefined criteria provided by the host system such that images provided to the host system are pre-adjusted and ready for effect generation. In this way effects may be generated more rapidly as adjustment processing functions are offloaded to capture systems rather than being performed entirely in the host system.

In another aspect of the present invention, interpolated intermediate images are generated from the adjusted and corrected original images based on calibration and virtual trajectory data. These interpolated images are then incorporated into the final video effect along with the adjusted and corrected original images. Given an interpolation algorithm of sufficient ability and quality, inclusion of interpolated images (or use of interpolated images alone) may create more desirable effect appearance; require fewer cameras to accomplish a given effect, or a combination of the above.

In a further aspect of the present invention, a user interface is provided on the host system for management, manipulation, and user interaction during the effect system process. Users or operators may set parameters before and/or during scene capture which dictate the time frame, location, and parameters of the effect.

In yet another aspect of the present invention, a method of creating complex video effects is provided using the system of the current invention.

The inventive system is implemented using a large number of cameras (sufficient to produce effects which appear to be footage from a single camera moving along a trajectory) which are arrayed around the scene from which the desired effect is to be generated. Visual information from a smaller subset of cameras in the array is captured and provided digitally in the working memory of a capture system as the scene progresses. The visual information from all cameras may be captured simultaneously by providing multiple capture systems which are commonly linked to a host system. Select images from the set of captured image data are provided for effect generation in the host computer in real time via a high speed network connecting all capture computers to the host computer. Inage adjustment and correction processes are performed in conjunction with effect generation to ensure smooth transitions and coloration throughout the generated video effect.

The 3-D Instant Replay system generally comprises the following components and functions: (a) spatially arranged camera array; (b) camera calibration routine; (c) digital capture of images; (d) virtual trajectory determination; (e) optional image adjustment processes; (f) optional interpolated image generation; (g) final effect generation; (h) user interface combining one or more of the above features as readily modifiable system elements to a system operator; (i) a method for generating effects using the above system.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a schematic diagram showing the overall 3-D replay system architecture

FIG. 2 is a schematic diagram showing the camera array, capture devices, sync device, host system and associated connections.

FIG. 3 is a schematic diagram showing the process by which multiple images from across the camera array are combined into a final video effect.

FIG. 4 is a schematic block diagram illustrating the example 3-D Instant Replay system

FIG. 5. is a schematic block diagram illustrating the user interface architecture of the 3-D Instant Replay system in accordance with one embodiment of the present invention.

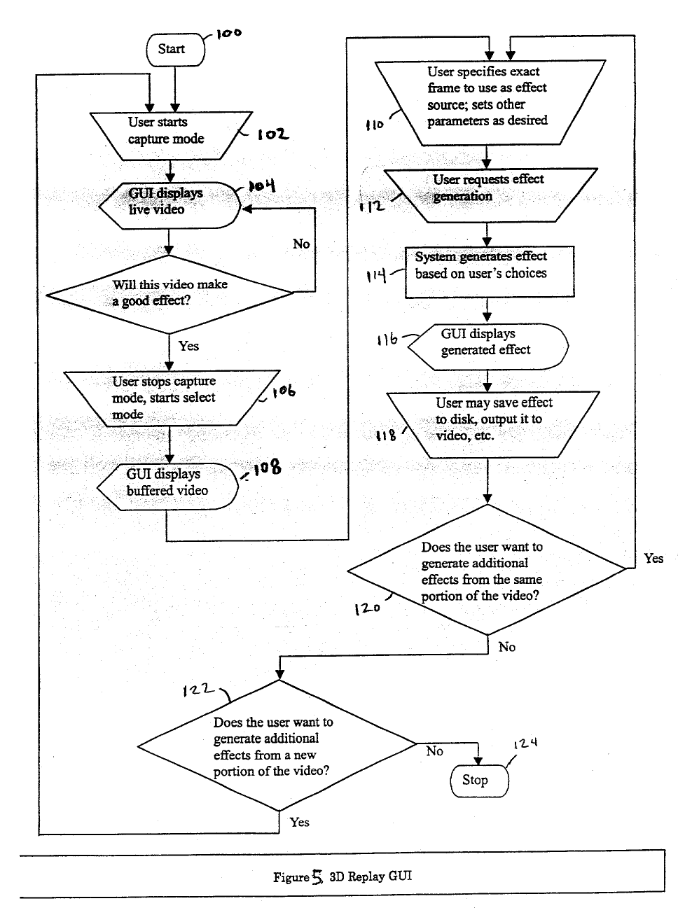

FIG. 6 is a process flow diagram showing the process for generating effects using present invention.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. It is understood that the 3-D instant replay concept of the present invention may be applied for entertainment, sports, military training, business, computer games, education, research, etc. It is also understood that while the present invention is best explained in reference to a 3-D “freeze and rotate” type of video effect, the amount of particular video effects made possible by this system is virtually limitless. In general for a given capture footage duration, effects from any instant in time or across any forward or backward trajectory through time, and from any single or combination of camera scene viewpoints are possible.

Overall System Design

The 3-D Instant Replay System allows for the real-time generation of complex 3-D and other video effects such that the viewing of effects is possible within moments after the subject event has been captured by the cameras. High quality video information from numerous cameras implemented about a desired scene is simultaneously captured and stored on multiple computer units and made available for effect generation. Based on predefined effect generation parameters or user input through a graphic user interface (GUI) on the host system, select images from the available video bank are provided in a host computer and simultaneously adjusted in real-time for inclusion in the final effect output. The final effect output constitutes a sequential or other desired combination of the selected images which is playable in a variety of formats, including formats suitable for television broadcast (also including instant replay capabilities), feature film sequences, or computer based viewing.

System Architecture and Process

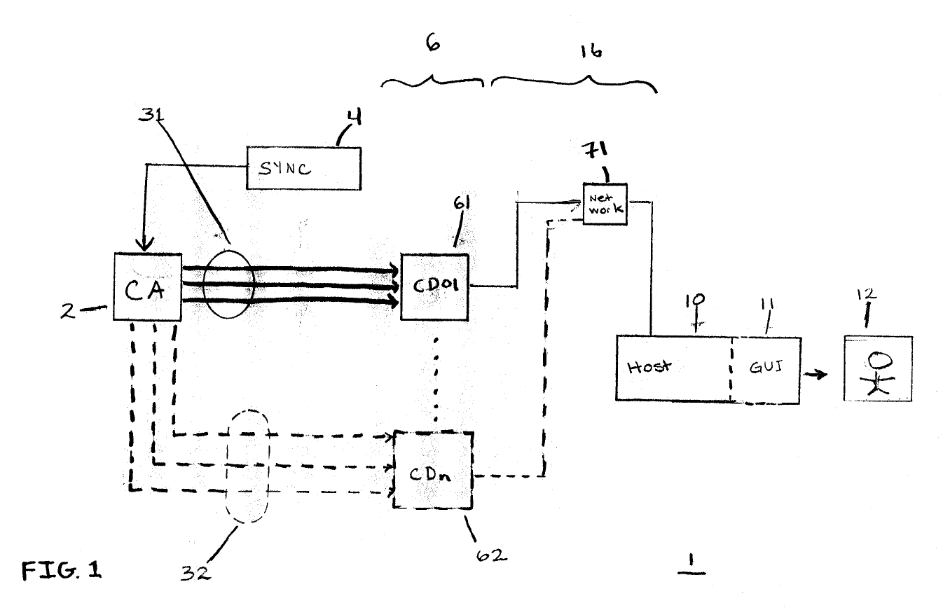

Looking now to FIGS. 1, 2 and 4, the 3-D instant replay system 1 is schematically shown to illustrate overall system architecture. Generally (looking at FIG. 1), camera array 2 is shown coupled to capture system 6 (which includes individual capture devices 61 and 62), and capture 10 system 6 is coupled to host system 10 via high speed network 16. Camera array 2 is connected to both sync generating device 4 and capture device 61. Video information signals 31 are shown being transferred from camera array 2 to capture device 61. Three video information signals (corresponding to three cameras from the array) are illustrated as being transferred to a single capture device in FIG. 1 in accordance with the example system (described below), however it is contemplated that significantly more than three total video information signals may be captured by a single capture system in accordance with this invention given sufficient visual imaging and computing technology. Additional capture device 62 and additional video information signals 32 are shown to illustrate the scalable architecture of a system containing more video information signals (and corresponding cameras) than can be captured adequately for effect generation by a single capture device. Capture system 6 thus may include one or more capture devices for adequately capturing all video information signals form camera array 2. In this regard, the architecture of the current invention is highly scalable and flexible to the particular needs involved in the capture and generation of a certain effect.

Sync generating device 4 is shown connected to the camera array 2 (each camera in the camera array is connected to the sync generating device via conventional cabling). Sync generating device 4 is illustrated as being as separate element of the system in FIG. 1, however it will be understood that implementations of the system which include synchronization devices integrated within individual cameras, capture devices, or the host system are possible without departing from the spirit or scope of the present invention. The purpose of the sync-generating device is to lock video information signals from each camera in the array to a common clock. The use of video synchronization devices is well known within the field of video technology, and generally the use of such devices will be necessary in the present invention to accomplish the high quality instantly playable 3-D rotational effects as described herein. However, it is noted that one may use the inventive aspects of the present invention without including a synchronization device, or by using an alternate means of synchronization such that images are provided in capture systems in a synchronous fashion. Such uses of the present invention should not be construed as limiting the scope or inventiveness of the current invention.

Network element 71 provides the backbone for image data and communication signal transfer between capture systems and the host system when configured as shown in FIG. 1.

Network element 71 is generally a high speed networking device (such as a Gigabit switch). Image data contained in any of the capture systems may thus be transferred through network element 71 and into host 10 via conventional network cards in each system. It will be appreciated that network element 71 is configured as shown in FIG. 1 in accordance with conventional high speed networks common in the computing industry. It should also be appreciated and understood that for purposes of transferring information between capture system 6 and host system 10, no particular network element 71 is required, and that for a given system 1 configuration, the characteristics of network element 71 will be determined partly by number of capture devices, amount of image data to be transferred, and time requirements in transferring a particular set of image information from capture system 6 to host system 10. It is also possible that the system 1 be configured such that no network element 71 is needed (ie. in a system where capture system 6 and host system 10 are configured in the same device). Generally network element 71 will serve to facilitate transfer of information between capture system 6 and host system 10.

Video information in the capture system may be provided at any time (preferably instantaneously upon capture or upon instigation of a an effect generation command by a user) to the host system for processing and effect generation such that output effect 12 results. Graphical user interface system 11 is shown as the user operable element of host system 10. Optionally, a hardware user interface (not shown) such as a media control surface common in video editing systems may be used to enable user interactions with the system and additional control over the effect generation process.

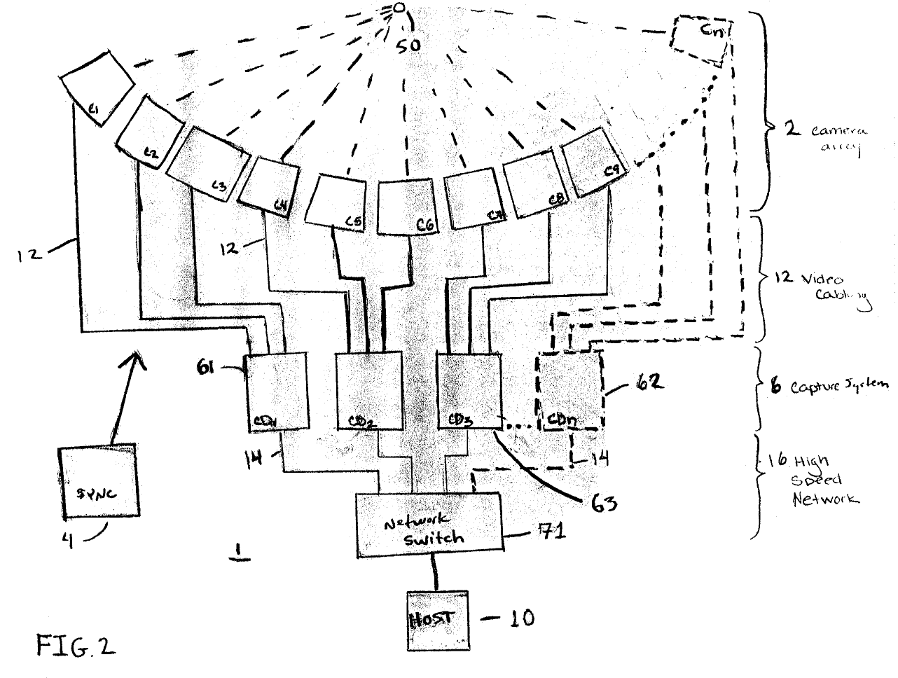

Typically for 3-D rotational effects the camera array 2 (as shown in FIG. 2), is configured to arcuately surround all or a portion of scene 50 where a particular event to be captured will take place. It should be appreciated that the particular orientation and positioning of cameras about the capture scene does not detract from the inventiveness aspects of the replay system described herein. Cameras may be positioned at similar heights and substantially equal distances from a common center point and from one another (such as an equal angular separation relative to the center point) in the capture scene to generate video effects from desired viewpoints. Certain camera array geometries may lend themselves to more simple setup and calibration functions (such as a substantially circular, or substantially square array), however, given each cameras ability to be pointed, focused, and zoomed with respect to its viewpoint, a virtually unlimited number of possible array geometries are possible. Generally, it will be desirable for effect generation purposes to position and orient each camera such that the viewpoint from each camera corresponds to the virtual viewpoint at each cameras location of a moving virtual camera traveling along a (generally smooth) virtual trajectory which passes through each cameras position. Each camera is also calibrated as to its spatial position, orientation, lens focal length and other known or modifiable camera parameters (discussed in greater detail below). With the positioned and calibrated camera array in place, any event occurring in the visible region (viewpoint) of all cameras may be captured by the camera array for generation of effects. Video image information from each camera is then provided in the capture and host systems storage and processing functions. In the example system described below, video image information from three separate cameras may be provided simultaneously to one capture device, thus in this embodiment, for every three cameras used in the array it will be necessary to provide one capture system. It is contemplated that given increases in video capture and computing technology, substantially more than three streams of video information may be captured by a single computer system. Thus, discussions contained herein concerning a three camera per capture computer configuration of the present invention should not be taken as limiting the inventive aspects, namely the instantaneous and simultaneous provision of visual information from multiple cameras in an effect generation system.

Example System

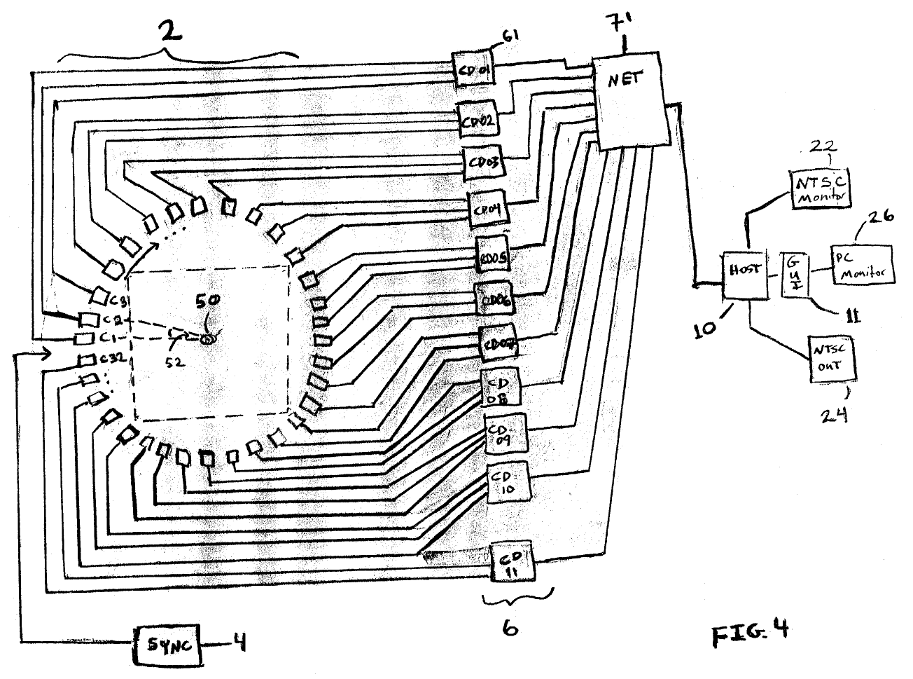

In one example 3-D Instant Replay system (shown schematically in FIG. 4), an array of 32 video cameras (shown as C1-C32) is used to surround a scene in which a subject event is to take place. Is the case of the example system the scene is a wresting ring, and the cameras are configured to surround the ring in a substantially circular array (*note, it is likely that in many ring oriented sporting events it will be most convenient to configure the camera array in a substantially square fashion which mirrors the shape of the ring, however circular configurations as shown in the example system are possible as well). Each camera is placed at an angular spacing 52 (from the center of the array) of approximately 11.25° from the next successive camera, thus creating a 360° span about the scene from which multiple camera viewpoints are possible. In general 32 cameras configured in this way will be sufficient to generate desirable 3-D “fly around” and “freeze-and-rotate” effects without the use of interpolation or other resource intensive image processing routines which tend to lengthen the effect generation time. 11 “capture” computer systems (CD01-CD11) equipped with three video capture cards which convert incoming analog video signals to digital information, gigabit networking hardware, 2 gigabytes of RAM, and dual Pentium III processors are configured to each capture up to three simultaneous video streams (so that groups of three cameras each from the camera array are linked to each capture system, with one capture system (CD11) being connected to only two cameras). A video sync generator 4, shown in FIG. 4 representatively linked to the camera array (in the example system each camera is connected to sync generating device 4), for synchronizing captured video frames across all cameras is connected to each camera. A host computer system comprised of similar components as each capture system is connected to each capture system via a networking element 71 (gigabit switch) and networking hardware in the host system. An NTSC capable monitor 22, PC monitor 26 are provided in the host system for viewing camera signals, effect output and GUI. NTSC output 24 is provided to host system 10 for sending the completed effects to a broadcast medium. A GUI system 11 is implemented on the host system for user/operator interaction with the effect generation process. Further detailed references and description of the example system above are made throughout the following sections, but should not be regarded in limiting each aspect as to its function, form or characteristic. Likewise, the example system is meant as purely illustrative of the inventive elements of the current invention, and should not be taken to limit the invention to any form, function, or characteristic.

Camera Array

In order to generate desirable video effects, especially those types of effects which appear to replay a scene which is frozen in time, it is necessary to capture multiple images from different camera viewpoints of the scene as it unfolds. There are a variety of methods that can be used to accomplish this element, including many that are described in detail in the prior art. (See U.S. Pat. No. 6,331,871 to Taylor; U.S. Pat. No. 5,049,987 to Hoppenstein). Generally, arrays of still or video cameras can be used to provide the set of images for use in effect generation. The array may be oriented in an arcuate fashion such that all cameras point operatively to a common point in a scene to be captured (as shown in FIGS. 2 and 4). It may be desirable, though not essential to the current invention, to maintain relatively small (approximately 10-12 degrees) equal angular distances between successive cameras and the center of the scene (as in the example system). Such a configuration may lend itself to less processing intensive effect generation algorithms, but is not necessary in order to practice the current invention. The optimal angular separation for a given desired effect will be partly determined by desired playback rate of the final effect. Generally it will be the case that effects using a slow rate of rotation (ie. slow motion effects) about the desired scene require relatively smaller angular separations between cameras than do effects which employ a high rate of rotation in systems where no image interpolation is used for final effect generation. In the example system example system the camera array is arranged such that equi-angular distances (approximately 11 degrees) occur (relative to a common center point) between each successive camera across the entire camera array such that a smooth, arcuate, two-dimensional virtual trajectory line may be formed which is incident the planes formed by each cameras two-dimensional viewpoint.

In the example system, the cameras are positioned in the array 6 (from FIG. 4) according to the following steps. First, cameras are attached to a tripod mount (approximately 6 ft high) on pan and tilt geared heads such that their orientation can be modified. Next the center of the 3-D scene to be shot is determined by tying a length string from one pole about the array to an opposite pole about the array. A second string is likewise tied across directly opposing poles to be substantially orthogonal to the first string. The point of intersection is deemed the center point of the scene for positioning purposes and is appropriately marked on the ground. Third, the field of view to be captured is determined. To accomplish this, a tripod containing a generally spherical target (could be any target which represents a subject to be captured during actual filming) is placed directly about the center point of the scene. The target is extended to an appropriate height (approximately 6 ft in the example system) to represent a sample subject to be captured. The optimal field of view will be different for each production situation, in the example system, given a square wrestling ring which is 20 ft×20 ft, the optimal field of view includes the whole of the ring (from each camera viewpoint) such that action in all areas of the ring will be visible at all times by all cameras. A ring with 20 ft diameter may be drawn or likewise indicated about the ring center point to guide orientation of the cameras in determining optimal field of view. With both the center point and field of view circle in place, each camera may be oriented to point at the center target with the zoom of each all the way out. It is preferred to use a video monitor (for performing camera adjustments) with “under scan” which shows the true edges of the video so pointing will be effective and accurate. Based on the visual representation on the monitor, each cameras orientation parameters are adjusted via the pan and tilt heads so that each is accurately centered on the center target while fully zoomed out. Once this is accomplished, each camera is zoomed in on the spherical “head” of the target (using leveling and tilt functions on the geared head) and focus is adjusted while the head is centered. A mark may be placed in the center of the video monitor to aid in centering of the head. From this point, each camera is zoomed out until the field of view circle (which was previously formed) is visible on the monitor's frame edge. The final camera-positioning step is to determine optimum iris level on the lens of each camera by adjusting the parameter in lighting conditions similar to those in which the actual scene will be shot.

In general, the camera placement will be limited only by available space in the desired setting. Once the available positions for camera placement are known, a conventional trigonometric calculation may be performed to determine the exact placement based on equal angles. A two-dimensional computer aided drafting (CAD) program may be used for laying out the cameras with equal angles. It is important to note that certain scene locations may require positioning of some cameras in the array off the ideal arcuate path. In such cases the image adjustment routines (detailed below) will compensate for imperfections in the camera array configuration. Once the cameras have been oriented in a desired (or necessary given a particular scene or effect) configuration, a calibration procedure is performed in order to provide necessary position, orientation, and internal camera parameter information which is used to compute the a virtual camera trajectory and for later image adjustment processes.

One method of calibrating the cameras (after the original manual placement and positioning) involves placing a target (generally a large checkerboard type target) at the center of the scene to be captured which is presented to all cameras in substantially all areas of the field of view for each camera via a series of rotations. All cameras have captured many views of the target in a sufficiently large number of different positions, the Intel Open Computer Vision (OpenCV) code routines are used to detect all the corners on the checkerboard, in order to calculate both a set of intrinsic parameters for each camera and a set of extrinsic parameters relative to the checkerboard's coordinate system. This is done for each frame where the checkerboard was detected. Given known position and orientation data for the target (ie. spatial and angular orientation of the target at various times during the calibration routine), relevant external and internal calibration may be determined. In the example system calibration data consists of the following parameters: External (extrinsic) parameters consisting of 3 position (x,y,z), 3 orientation (θ, φ, ω); Internal (intrinsic) parameters: 1 or 2 lens distortion (k1, k2), 1 focal length f, 1 aspect ratio α, 2 image projection center (cx, cy) which are generated by a camera calibration algorithm and stored in the host system for access and use during virtual trajectory determination, image adjustment, image interpolation, and final effect generation processes. It is also possible, if two cameras detect the checkerboard in the same frame, that relative transformation between the two cameras can be calculated. By chaining estimated transforms together across frames, the transform from any camera to any other camera can be derived. The algorithm used during calibration is derived from the commonly known Intel OpenCV Code library which may be adapted to serve a system having multiple cameras such as the example system described herein.

An alternate method of positioning and calibrating the cameras involves the use of motorized camera mounting systems such that each camera may be manipulated remotely as to its relative position, orientation, and even focal length (zoom) properties. A targeting system may be used to determine relevant calibration data for each camera, though in general such calibration must be performed each time the cameras are moved. Additionally, each camera mounting system may be operatively connected to the host system such that calibration routines performed from the host system may manipulate one or more cameras automatically as to its position and/or orientation in response to feedback data or other triggers present in the host system. In this way the system may be configured to be self-calibrating, such that the most desirable results for a given effect are achieved in the shortest amount of time. User command input on the host computer can also be used to manipulate camera position and orientation from a distance. Position and calibration data from each camera is then determined directly by the host computer based on feedback data from each camera. Such data is then stored in the host system for access and use during virtual trajectory determination, image adjustment, image interpolation, and final effect generation processes. It should be noted that while additional flexibility in terms of final effect generation, camera positioning, and calibration processes may be achieved by use of such as motorized mounting system, an additional level of complexity and cost are involved in the effect generation system which may be undesirable for many applications.

Video Capture, Storage, and Access

In order to make available multiple time locked sets of image frames of a scene for desired effect generation, it is necessary to synchronize, capture and store the video information from many different cameras. In addition, the capture and storage of video information on each capture system, as well as the providing of relevant portions of video data in the host system, must be performed relatively quickly (on the order of a few seconds) if instant replay type effects are to be achieved. The 3-D Instant Replay system of the current invention includes realtime video capture, storage, and access capabilities such that true “instant replay” type effects are possible. In the example system, high quality analog video cameras are used in the camera array (such as any camera capable of generating broadcast quality image information) though it should be understood and appreciated that virtually any camera may be used which generates a video signal capable of being captured on or transmitted to a computer device. For systems using image interpolation, the minimum camera specifications would be determined by the image quality requirements of the particular interpolation algorithm used.

In the example system, video information generated by the video cameras is in the form of NTSC signals which are transmitted via commonly used video cable (such as coaxial cable) to one or more capture system. Many other analog video signal formats could be used similarly (such as composite or RGB video) to transmit video information to the series of capture systems. In order to ensure that video data from each camera in the array captures frames of image information at the same instant as all other cameras (which is necessary for the generation of many types of effects contemplated in the present invention) a video sync generator along with a set of video distribution amplifiers may be connected to each camera via BNC or other similar cabling. Such synchronization setups are common in the professional video industry. Once the video signal generated by each camera is synchronized, image information from multiple cameras is ready to be captured substantially simultaneously by each capture system.

In the example system, each capture system is generally a computer (such as any IBM compatible personal computer) containing one or more video capture elements (such as an Imagenation video capture card), a networking element (such as Gigbit Ethernet or any sufficiently high speed networking card), a microprocessor element (in one example system dual Pentium III 1 Gigahertz processors), memory element (such as random access memory) and a fixed storage element such as one or more hard disks. In general the elements indicated above are common components of computing devices known in the industry. For the quickest possible generation of desirable effects, it will be advantageous to maximize the performance of each element to whatever degree technologically feasible, though it should be appreciated that effects may be generated sufficiently with systems having less than optimal characteristics.

In general, the more data throughput available in the network element, the greater the amount of video information able to be simultaneously transmitted to the host system for effect generation. Similarly, the greater the processing power of the microprocessor element, the greater the speed at which signal conversion and other system processes may be performed. Because captured video information must be stored in the system memory element of capture systems (as opposed to the fixed storage element) to enable real time effect generation, it is particularly important to maximize the amount available in each capture system for storage. For example, typical broadcast quality signals from three cameras captured by a capture system will take approximately two gigabytes of memory storage per 30 seconds of readily available video information for effect generation purposes. Once the available amount of memory storage has been reached in each capture system during capture sequences, the data may be transferred to the fixed storage elements for long term storage and later effect generation. Those skilled in the art will appreciate that given alternate improved data storage means (such as faster hard disc drives or removable media), currently known RAM memory technologies may not lends the best results for 3-D instant replay. Currently, direct storage of image information to fixed storage devices on the capture systems is limited only by the amount of data throughput available in such devices for the simultaneous capture of footage while effects are being generated. Thus, it will be advantageous given the current state of storage media, in most real time effect generation systems, to maximize the amount of available memory in each capture computer.

In the example system, three capture cards are placed in each capture system thus enabling three cameras from the camera array to be connected to one capture system for video capture purposes. Because each capture system is networked to the host system via the high speed network elements, many capture systems may be linked together to simultaneously capture the video from many video cameras. For example, in a system containing 32 video cameras, 11 capture systems would be necessary to enable the simultaneous capture of all video streams from the camera array. As video data is present in the working memory of each capture system, it may selectively be provided to the host system for effect generation. It should be understood and appreciated by those skilled in the art that the exact number of capture systems necessary to capture all video data from a given camera array, including the number of video capture cards which may be implemented in each capture system, will vary widely given the state of video and computing technology. The present invention seeks only to describe and illustrate the ability, via multiple capture systems which are networked together, to capture high quality (generally 30 frames per second (FPS) of NTSC format video) video data from multiple cameras relatively instantly and synchronously such that at any given moment in time, readily available video data for effect generation is present in the working memory of each capture system. It may be possible given appropriate advances in computing and video capture technology to significantly reduce the number of capture systems necessary for a given camera array, such advances however would not change the inventiveness or novelty of the present invention which is directed to the instant replay of complex 3-D or other video effects through distributed capture of video information in multiple capture systems and selective provision of such data to a host system for processing.

In an alternate embodiment, digital video cameras are provided in the camera array as opposed to traditional analog video cameras. Because video information is converted to digital data within each camera before it is transmitted to the capture systems, signal processing elements (such as the video capture cards of the preferred embodiment) are not necessary.

Instead, digital information is transferred from the cameras to the capture systems via one or more IEEE 1394 Firewire interfaces on each capture system and associated cabling. After transmission to the capture system, data is made available in the working memory for immediate effect generation as described in the preferred embodiment.

A host computer system, generally consisting of a computer system such as those described for each capture system, with the addition of video display element, such as an NTSC-capable video card and video output monitor, is provided to monitor incoming video data into each capture system, monitor synchronization information from the video sync generator and run both user interface and effect generation software.

Virtual Trajectory Generation

In order to ensure the generation of smooth, believable output effects, and in the case where interpolated images are to be generated, it will be necessary to calculate a “virtual camera trajectory” from system calibration data which corresponds to the path a real camera would have to follow about a given scene to create a certain effect. In order to determine the virtual trajectory, internal camera parameters (such as lens characteristics and focal length) are smoothly interpolated between the first and last cameras of a given array. This interpolation helps to ensure consistent viewpoint distances from frame to frame in the generated output effect. The camera position is then interpolated along a smooth trajectory that passes as close as possible to the actual camera positions. In the example system cameras are configured such that a smooth trajectory which passes nearly exactly through each camera position is possible. The function defining such trajectory can be circular in nature, or it may be cycloidal or linear. In the example system, a least-squares function is used to fit the actual camera positions to the desired function. Interpolation between successive images is not used in the example system (due to the large number of camera and corresponding images of the scene) and as such, only this first virtual trajectory calculation (generally an interpolation of camera orientation parameters) is necessary accomplish image adjustment processes.

For systems which include image interpolation as a means for generating additional effect images, additional calculations, corresponding to both orientation and position data of the virtual cameras, must be determined to effectuate sufficient results. In this case, the position and orientation parameters of a virtual camera at a given location along the calculated virtual trajectory must be carefully interpolated in three dimensions. This is especially critical in cases where interpolated images are to be generated prior to final effect generation. Generally the orientation parameters of a virtual camera are separated into a two-dimensional pan and tilt component, and a one-dimensional roll component. Using an axis-angle formulation of 3-D rotation the pan and tilt components may be interpolated. Known processing functions are used to determine each axis/angle component, such as the Intel Corporation Small Matrix library. The roll component may be interpolated linearly. For a given virtual trajectory and known real camera orientation data, it would be possible to calculate an unlimited number of virtual camera positions, however for effect generation purposes it is only necessary to generate virtual camera position data at points along the trajectory which correspond to interpolated image viewpoints which are to be generated.

Image Adjustment

Due to inherent limitations in the ability to perfectly calibrate cameras, aberrations in lighting and other ambient system characteristics, and the image deviations introduced during video capture due to system disturbances and/or perturbations, it will generally be necessary to perform certain adjustments on each original captured image to be used in a desired effect prior to or during the effect generation process in order to produce output effects of sufficient quality for use in current video applications (such as broadcast television, or DVD media). The image adjustment process differs from the camera calibration process in that camera calibration is done before actual images are captured by the system. As much as possible it is desirable to initially position the cameras very precisely in order to create the smoothest most uniform effects possible without image adjustment. Due to factors such as those mentioned above however, even in very precisely positioned camera arrays under optimum lighting and environment settings, the captured images themselves generally must undergo vibration compensation, color correction, and image adjustment processes to produce resultant effects of sufficient quality for broadcast television of film standards. It is contemplated that the current invention may be useful in certain applications where highest output quality of the effect is not important without performing any image adjustment routines. As such, the image adjustment processes, color correction, image perspective warping, and vibration compensation, are necessary only so far as the required quality of the output effects dictates. For the example system of a sporting event (instant replay 3-D effects of professional wrestling) which is to be broadcast on television, it is necessary to perform all three image adjustment processes to effectuate outputs effects of sufficient quality.

In the example system, from a process flow perspective, camera calibration data is collected during the initial system setup and stored in the host system, virtual trajectory parameters corresponding to the orientation data of virtual cameras positioned substantially in the same location as real cameras are calculated based on calibration data, finally image adjustment routines are performed (as detailed below) using the virtual trajectory data of each camera.

Two distinct image adjustment processes are generally necessary to ensure adequate effect results. First an image correction process is performed. The color balance and brightness of images from successive cameras is corrected in order to create smooth variations between the values from start and end cameras. This process is accomplished by computing the mean image color of the first and last images, and linearly interpolating this color to produce a target value for each intermediate image. The difference between the actual image mean color and the target image mean color is added to each pixel. It will be appreciated by those skilled in the art that many different approaches to and possibilities for color and brightness correction will be possible without departing from the scope of this present invention.

The second image adjustment process constitutes a warping algorithm which corrects the effects of camera positioning inadequacies during capture on the final effect output. Using camera calibration and virtual trajectory information, an image warping algorithm can be used to virtually point the cameras (such that images captured from the actual cameras are altered with respect to their original viewpoint) at a desired point in space. In the preferred embodiment, a commercially available image warping algorithm (such as the ip1WarpPerspective algorithm currently available from Intel Corporation) is used to correct image perspectives and viewpoint prior to final effect generation. In general any algorithm which implements an 8-parameter perspective warping function may be used to accomplish the desired effect of the present invention. A detailed description of such image warping methods may be found in “Digital Image Warping” by George Wolberg, IEEE Computer Society Press, 1990]

Additionally, in certain settings and instances, it will be necessary to perform an optional vibration compensation routine. Vibration compensation may be performed before both color correction or image warping. During initial system calibration, position data from certain fixed objects in the field of view of each camera is generated and stored on the host system in the form of a reference image for each camera. Each incoming image for effect generation is then compared to the stored object position data such that deviance in the actual field of view (x and y axis deviations) captured by the camera (due to system perturbations, disturbances, or a variety of other factors) may be determined by the offset of object position data in the incoming effect image. The object is to slide the incoming image around in the field of view plane and determine the position which causes the best match with data from the calibration image. Every possible offset in a limited range (corresponding to the largest possible offset distance given normal camera perturbations) is tested, and for each offset, the offset is calculated. A sum of squared differences (SSD) function may be used for this calculation. The calculated offset that yields the lowest SSD value is chosen, and the pixels of the incoming image are offset by that value.

Image Interpolation

In another aspect of the current invention, image interpolation algorithms and techniques may optionally be employed during the final effect generation process as a means to add one or more “intermediate” images between original images from successive cameras. This process may be useful in that the final output effect may appear to be smoother and more believable to an audience due to the additional interpolated frames. It may also be used to reduce the number of cameras need to accomplish a given effect. Generally the body of interpolation algorithms known as Image Based Rendering (IBR) may be used to create the intermediate images which fall between real camera images, though no algorithms known to the inventor currently exists which both produces sufficient quality output images and is sufficiently robust for use in the current system.

A detailed description of the process and use of such interpolation functions may be found in “Forward Rasterization: A Reconstruction Algorithm for Image-Based Rendering,” by Voicu Popescu, UNC Dept. Comp. Sciences TR01-019. Generally, using virtual trajectory data calculated by the above described processes, pixel data from two successive images to be included in an output effect may be warped and rendered to an intermediate image such that the intermediate image appears to have been captured from a viewpoint somewhere between the viewpoints shown in the original images.

Final Effect Generation

In order for a desired effect to be viewable in standard medium such as broadcast (NTSC, HDTV, or other format), video (VHS, DVD, etc) or computer viewable (MPEG, AVI, MOV, etc), the final corrected, calibrated, and optionally interpolated sequence of image frames must be combined and output for viewing using one or more known codecs, conversions, or media recording devices. In the example system the sequence of images constituting the final effect is played back in succession from the host computer as an output video signal (NTSC) at thirty frames per second which may be broadcast live on television and/or optionally recorded into a video recorder (such as a Betacam or VHS recorder) for storage purposes.

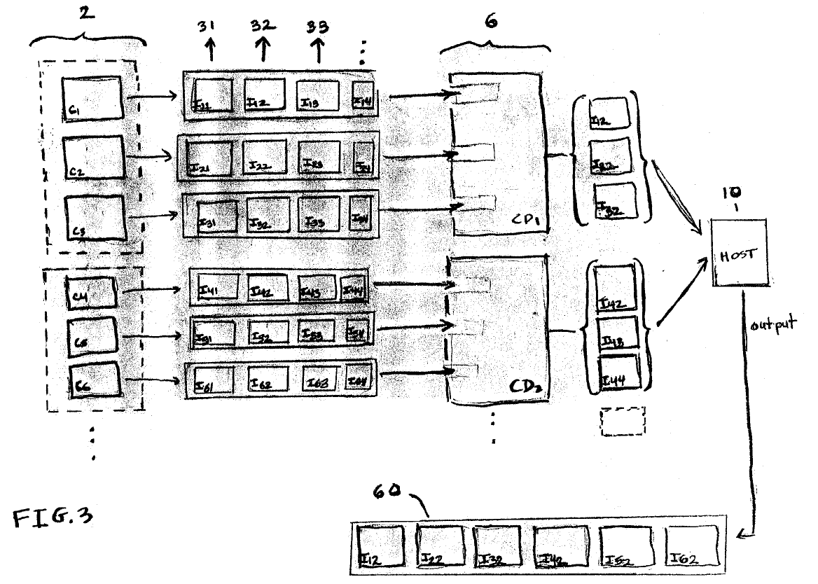

Looking to FIG. 3, output effect 60 is shown generated from individual frames (112, 122, 132, 142, 152, 162) taken from the set of frames (I11-I64) generated by cameras C1-C6 from array 2. This diagram illustrates the nature of an output effect drawing individual frames from successive cameras across a fixed duration of time. Given a camera array as shown in the example system (FIG. 4), the final effect shown in FIG. 3 would appear to be he viewpoint of a single camera traveling around the desired scene while motion in the scene is still progressing. It should be appreciated that a freeze-and-rotate type of effect could be easily generated by using successive images from across all cameras at a given instance in time (represented in FIG. 3 at 31, 32, or 33).

In reference to the time in which desired effects may be generated by the example system, generally, including the time it would take an average user to select a desired frame (corresponding to an instance in time 31, 32, or 33) for effect generation, the process to generate a slow motion (defined as ⅓ speed), 5-6 second freeze-and-rotate effect which plays back at NTSC quality (ie. 30 frames, or 60 fields per second) will take approximately 10 seconds. It will be appreciated by those skilled in the art that the time for effect generation in any given system will be partly governed by the speed of various elements involved (ie. network hardware, processors, memory speeds, etc) and thus, increasingly rapid effect generation times will be possible given the use of faster system elements.

User Interface

In a further aspect of the 3-D Replay System of the present invention, an optional graphic user interface (GUI) may be included for allowing a human operator to interact with the effect generation process. In general the user interface system will enable the user to control the video selection and effect generation process from one single computer (host system) in a real time fashion (i.e. a user may select a specific moment or span of time as a scene occurs from which to generate an 3-D Instant Replay effect). The user may preview live video data from the system camera array, select a desired moment or span or time from which to generate an effect, choose a desired video effect routine and associated parameters (i.e. 3-D rotation effect about a two second time period played in reverse), and generate the effect on demand. Optionally, a hardware user interface such as a media control surface common in video editing systems may be used in conjunction with a GUI, or as a standalone interface to the effect system.

Referring now to FIG. 4, at Start state 100 the 3-D Replay system is in a static state, fully configured to capture video data but not yet in an activated capture state. At state 102 a user activates “capture mode” in the user interface system. Capture mode corresponds to a system command set which enables each camera, each capture system, and all associated hardware to begin real-time capture of video data from the scene. In state 104 the user interface system displays a live video preview from any of the cameras based on user selection. By entering data or command information into the user interface a user may specify video data from any camera attached to the system to display on a monitoring system such as a computer screen, video monitor, or other video display device. In state 106, upon viewing relevant video content for effect generation, user deactivates “capture mode” and activates “select mode” in the user interface system. In the example system, cameras are not powered off in select mode, but remain ready to capture additional footage given reentry into capture mode. It is also contemplated that given sufficient fixed storage space on each capture system, all cameras could continue to transmit video data to the capture computers for storage while a user manipulates existing footage in select mode on the user interface system. This would allow the greatest flexibility and range or video data available for future effect generation use. In state 108, upon entering select mode, the last several seconds of captured video are stored by the user interface system for examination and possible effect processing. In state 110 the user may scroll back and forth in the stored portion of video to locate the precise moment or portion of the video that will be used to generate the effect. In state 112, after selection of the video content, the user may customize certain effect generation parameters such as rotation center (for 3-D rotation video effects), effect duration, effect algorithm, frame advance rate (for video effects across a set duration of time), and frame advance direction (forward or reverse). In state 114, once all video content selection and associated parameters have been set, the user may activate the effect generation process in the user interface system. A keystroke or onscreen button may initiate the effect generation process. In state 116, after effect generation is complete, the user may activate a playback mode in the user interface system to review the output effect, the effect may then be saved to a video recorder, or the file may be saved in the host computers storage system for later retrieval 118. In state 120, the user may then generate additional effect from the same portion of video (by returning to state 110) or may elect to generate additional effects from a new portion of the video 122 by returning the user interface system to capture mode in order to capture additional footage from which to generate effects. Optionally the user may stop the effect generation process 124.

Process Flow

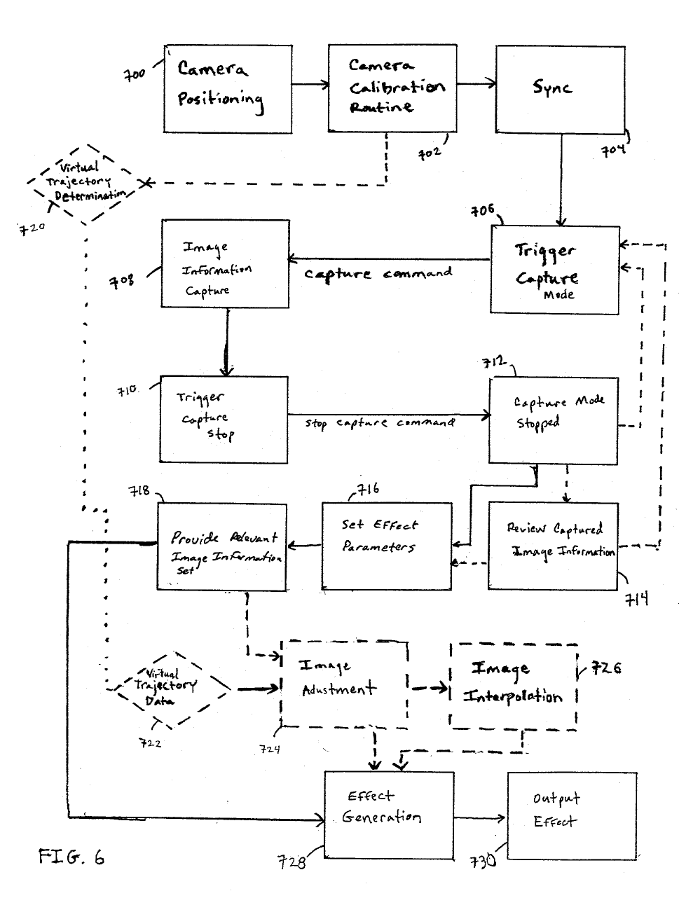

Looking now to FIG. 6, a block diagram showing the overall system process flow is shown. Initially, multiple cameras are positioned 700 in an array or other desired configuration and then calibrated 702 to determine external (extrinsic) and internal (intrinsic) parameters. It is possible at any time after calibration to use generated calibration data to calculate virtual trajectory data for the system 720. For illustrative purposes the virtual trajectory determination step 720 is shown providing virtual trajectory data 722 during the optional image adjustment step 724. It is also possible to generate virtual trajectory data at any time after camera calibration and before image adjustment processes (where it is used). Virtual trajectory determination need only occur once.

As events occur in the scene, synchronization of the cameras is started 704, and user input parameters or preset system parameters trigger camera capture mode 706. Capture commands are sent from the host system to the capture system to begin capture of image information 708. After a system preset time, or upon further user input, capture mode is stopped 710. Stop capture commands are sent from host to each capture system to disable capture mode 712. In this state, a fixed amount of synchronized image information data (in the form of image frames) exists in each capture system. Based on user interaction with the system, steps 706 through 712 may be repeated until relevant or desired video data exists in the memory of each capture system. At this stage 714 image information from the capture system may be reviewed (by a user), or capture mode 706 may be re-triggered to generate more image information. To generate effects, preset effect parameters or user defined effect parameters are input in the host system 716. Based on these parameters relevant portions of image information (select image frames) from the capture system are transferred to the host system 718. The relevant portions of image information may immediately be generated into an effect 728, and output in a desire format 730, however generally to produce high quality effect an optional image adjustment step 724 is performed. Virtual trajectory data is provided 722 from the prior virtual trajectory determination 720. Using the virtual trajectory data, during the image adjustment step 724, each frame of relevant image information undergoes one or more image adjustment processes generally consisting of a vibration compensation routine, color correction routine, and image warping process. Additional image adjustments may also be performed to render the set of relevant images suitable for high quality effect generation. As mentioned previously, it is contemplated that for given applications requiring a lesser degree of output effect quality than would be necessary for typical television broadcast standards, each of the image adjustment routines would be optional as they are implemented in the example system as a means for generating high quality output effects. The set of adjusted image frames is at this state ready for immediate effect generation 728, or may optionally be used in an image interpolation algorithm 726 to generate additional relevant images for effect generation. In the case of image interpolation, an additional number of image frames is generated from the original relevant image frames and generally sequentially combined with the originals, though it would be possible to generate the final effect using any sequential (for rotational effects) combination of original and interpolated images, including generating an effect with only interpolated images. The final step is generation of the effect 728. Output of the effect 730 for desired media (such as an NTSC output signal) is optional, but will generally be desired.

The process and system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

We claim:

1. A video effect generation system, comprising:
an imaging array comprising a first imaging device and a second imaging device;
an image capture system configured to capture a first set of image information from said first imaging device and a second set of image information from said second imaging device;
an image processing system for selecting a first subset from said first set of image information and a second subset from said second set of image information to produce a generated video effect sequence.

2. The video effect generation system as in claim 1, wherein said imaging array conforms to a generally smooth trajectory path.

3. The video effect generation system as in claim 2, wherein said smooth trajectory path corresponds to a virtual trajectory which would be followed by a single virtual camera to produce a video sequence corresponding to said generated video effect sequence.

4. The video effect generation system as in claim 3, wherein said first imaging device and said second imaging device are disposed at different points along said smooth trajectory path.

5. The video effect generation system as in claim 4, wherein said first imaging device and said second imaging device are oriented toward a common scene, said first imaging device depicting a first viewpoint of said common scene, and said second imaging device depicting a second viewpoint of said common scene.

6. The video effect generation system as in claim 5, wherein said first viewpoint comprises a first field of view and said second viewpoint comprises a second field of view, said first field of view corresponding to the field of view of said virtual camera on said virtual trajectory at substantially the same spatial location and orientation as said first imaging device, and said second field of view corresponding to the field of view of said virtual camera on said virtual trajectory at substantially the same spatial location and orientation as said second imaging device.

7. The video effect generation system as in claim 1, wherein the said imaging array is provided as a calibrated array such that extrinsic and intrinsic parameters of each said imaging device are generated.

8. The video effect generation system as in claim 1, further comprising a synchronization means such that at time Ti, image frame 11 from said first set of image information and image frame 12 from said second set of image information are captured in said image capture system substantially simultaneously.

9. The video effect generation system as in claim 1, wherein said image capture system comprises a first image capture device and a second image capture device, said first image capture device being coupled to said first imaging device and said second image capture device being coupled to said second imaging device.

10. The video effect generation system as in claim 9, wherein the imaging array includes additional imaging devices forming a plurality of imaging devices, each additional imaging device disposed along said trajectory path and oriented toward said common scene such that additional viewpoints, each said additional viewpoint including an additional field of view corresponding to the field of view of said virtual camera on said virtual trajectory at substantially the same spatial location and orientation as each said additional imaging device.

11. The video effect generation system as in claim 10, wherein said first image capture device is coupled to a first set of imaging devices from said plurality of imaging devices, and said second image capture device is coupled to a second set of imaging devices from said plurality of imaging devices.

12. The video effect generation system as in claim 1, further comprising an image adjustment means.

13. The video effect generation system as in claim 12, wherein said image adjustment means comprises a vibration calibration routine, a color correction process, and a perspective warping process.

14. The video effect generation system as in claim 1, further comprising a user interface for interacting with one or more system elements such that said generated video effect sequence corresponds to a desired set of parameters set by a user.

15. A method of generating video effects comprising the steps of:
positioning a first imaging device and a second imaging device in an array;
capturing a first set of image information from said first imaging device and a second set of image information from said second image device in an image capture system coupled to said array;
selecting a first subset of image information from said first set and a second subset of image information from said second set in an image processing system coupled to said capture system;
generating a video effect sequence from said first subset of image information and said second subset of image information in said image processing system.

16. A method as in claim 15, wherein said positioning step further comprises the steps of:
calibrating said first imaging device and said second imaging device;
providing calibration data in said processing system

17. The method as in claim 15, wherein said capturing step comprises the steps of:
synchronizing said first imaging device and said second imaging device;
triggering a capture mode in said image capture system;
capturing image information in said image capture system.

18. The method as in claim 15, wherein said selecting step further comprises the steps of:
providing video effect sequence parameters;
determining a first relevant set of image information from said first set of image
information based on said parameters;
determining a second relevant set of image information from said second set of image information based on said second parameters;
providing said relevant sets of image information to said image processing system.

19. The method as in claim 18, wherein said first set of relevant image information comprises a first image frame and said second set of relevant image information comprises a second image frame.

20. The method as in claim 19, wherein said step of generating a video sequence further comprises the steps of:
adjusting said first image frame and said second image frame;
sequentially ordering said first image frame and said second image frame in a desired order;
creating a video effect sequence.

21. The method as in claim 15, wherein said step of generating a video sequence is performed substantially in real time, such that said video effect sequence may be played back to a viewer immediately after said selecting step.
